(19) United States
(12) Patent Application Publication
(10) Pub. No.: US 2021/0342703 A1
(43) Pub. Date: Nov. 4, 2021

(54) GENERATIVE ADVERSARIAL NETWORKS FOR TIME SERIES

(71) Applicant: Siemens Aktiengesellschaft, Munich (DE)

(72) Inventors: Qi Wei, Monmouth Junction, NJ (US); Chao Yuan, Plainsboro, NJ (US); Amit Chakraborty, East Windsor, NJ (US)

(21) Appl. No.: 17/271,646

(22) PCT Filed: Aug. 31, 2018
(86) PCT No.: PCT/US2018/049216

§ 371 Date: Feb. 26, 2021

(51) Int. Cl. G06N 3/08; G06N 3/04

(52) U.S. Cl. CPC G06N 3/088; G06N 3/0472; G06N 3/0454

(57) ABSTRACT

Systems, techniques, and computer-program products are provided to generate synthetic time series using a generative adversarial network. In some embodiment a technique includes configuring a first neural network having a first function representative of an output of the first neural network, and configuring a second neural network having a second function representative of an output of the second neural network. In addition, such a technique includes generating a generative adversarial network by solving an optimization problem with respect to an objective function based at least on the first function and the second function. The generative adversarial network includes a discriminator neural network and a generator neural network. A synthetic time series can be generated using at least the generator neural network.

### BACKGROUND

Numerous system and techniques are available to measure observable quantities over time. From ultrafast optical spectroscopy to longitudinal studies of geological formations, monitoring an observable quantity can be accomplished generally reliably. Even in complex systems (such as systems that present chaos or include other types of stochastic phenomena) having multiple relationships between quantities that determine observable phenomena, an observable quantity usually is available and can be probed. Yet, such complexity hinders the generation of realistic time series of an observable quantity, rendering such task difficult, if not plainly unfeasible. Therefore, much remains to be improved in the generation of time series.

### BRIEF DESCRIPTION OF THE DRAWINGS

The accompanying drawings are an integral part of the disclosure and are incorporated into the present specification. The drawings, which are not drawn to scale, illustrate example embodiments of the disclosure and, in conjunction with the description and claims, serve to explain at least in part various principles, features, or aspects of the disclosure. Some embodiments of the disclosure are described more fully below with reference to the accompanying drawings. However, various aspects of the disclosure can be implemented in many different forms and should not be construed as being limited to the implementations set forth herein. Like numbers refer to like, but not necessarily the same or identical, elements throughout.

FIG. 1 presents an example of an operational environment for generation of synthetic time series in accordance with one or more embodiments of the disclosure.

FIG. 2 presents an example of an industrial machine that generates observed time series that can serve as training datasets for the generation of synthetic time series, in accordance with one or more embodiments of the disclosure.

FIG. 3A presents an example of a system for generation of time series in accordance with one or more embodiments of the disclosure.

FIG. 3B presents another example of a system for generation of time series in accordance with one or more embodiments of the disclosure.

FIG. 4 presents a table that characterizes an example of a layer structure of a discriminator neural network in accordance with one or more embodiments of the disclosure.

FIG. 5 presents a table that characterizes an example of a layer structure of a generator neural network in accordance with one or more embodiments of the disclosure.

FIGS. 6-11 illustrate performance of an example GAN for generating synthetic time series in accordance with one or more embodiments of the disclosure. Specifically, FIG. 6 presents examples of observed time series and synthetic times series generated in accordance with one or more embodiments of the disclosure, both types of time series represent spindle motor AC current (labeled SMC AC) in an industrial machine;

FIG. 7 presents other examples of observed time series and synthetic times series generated in accordance with one or more embodiments of the disclosure, both types of time series represent spindle motor DC current (labeled SMC DC) in an industrial machine;

FIG. 8 presents other examples of observed time series and synthetic times series generated in accordance with one or more embodiments of the disclosure, both types of time series represent table vibration in an industrial machine;

FIG. 9 presents other examples of observed time series and synthetic times series generated in accordance with one or more embodiments of the disclosure, both types of time series represent spindle vibration in an industrial machine;

FIG. 10 presents other examples of observed time series and synthetic times series generated in accordance with one or more embodiments of the disclosure, both types of time series represent acoustic emission (AE) at a table in an industrial machine; and

FIG. 11 presents other examples of observed time series and synthetic times series generated in accordance with one or more embodiments of the disclosure, both types of time series represent AE at a spindle in an industrial machine.

FIG. 12 presents an example of a method for generating times series in accordance with one or more embodiments of the disclosure.

FIG. 13 presents an example of an operational environment in which generation of a time series can be implemented in accordance with one or more embodiments of the disclosure.

### DETAILED DESCRIPTION

The disclosure recognizes and addresses, in at least some embodiments, the issue of generation of time series. Embodiments of the disclosure include systems, techniques, and computer-program products that, individually and/or in combination, permit or otherwise facilitate generating time series using generative adversarial networks. As is described in greater detail below, the disclosure provides, amongst other things, generative adversarial networks (GANs) that generate realistic real-valued multi-dimensional time series. A GAN includes emerging artificial intelligence processes for both semi-supervised and unsupervised machine learning, through implicitly modeling a distribution of high-dimensional data. More particularly, the GAN includes a generator neural network and a discriminator neural network. The generator neural network can be embodied in or can include, for example, a deconvolutional neural network. The discriminator neural network can be embodied in or can include, for example, a convolutional neural network. Rather than relying on backpropagation, the disclosure utilizes an unsupervised approach to train a GAN to generate a time series. Specifically, embodiments of the disclosure apply adversarial training to observed time series (or time series data) in order to configure the GAN to generate a synthetic time series. Performance of GANs in accordance with aspects of this disclosure is illustrated by comparing observed time series in an industrial machine with synthetic time series generated with a trained GAN of this disclosure.

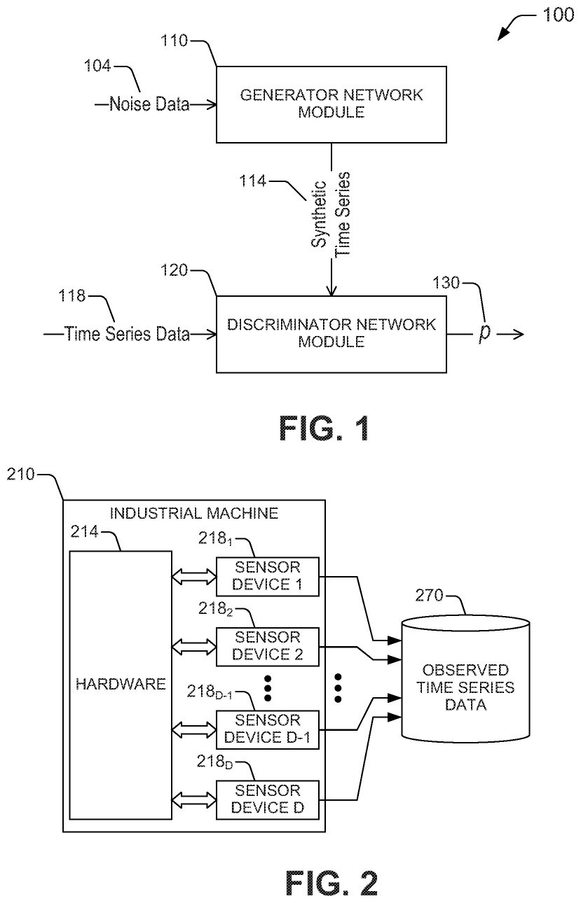

With reference to the drawings, FIG. 1 presents an example of an operational environment 100 to generate times series using a generative adversarial network, in accordance with one or more embodiments of the disclosure. The illustrated operational environment 100 includes a generator network module 110 and a discriminator network module. The generator network module 110 and the discriminator network module 120 can implement respective neural networks: a generator neural network (or generator network) and a discriminator neural network (or discriminator network). Each of such neural network competes with each other in a zero-sum game framework.

In one example, the generator network module can create a synthetic time series 114 from random noise data 104 in an attempt to generate a realistic time series. The discriminator network module can receive the synthetic time series 114 and observed time series data 118, and can attempt to distinguish them. The discriminator network module 120 can identify a synthetic time series with a probability p 130.

The generator neural network and the discriminator neural network can be trained simultaneously, for their respective goals, to achieve Nash equilibrium. More specifically, the goal of the generator neural network is to learn to map from a latent space (random noise) to the data distribution of observed time series of an observable quantity (e.g., physical property). The discriminator neural network can discriminate between samples from the observed data distribution and synthetic time series produced by the generator neural network, as implemented by the generator network module. The training objective of the generator neural network is to deceive the discriminator neural network by producing synthetic time series that appear to be drawn from the observed data distribution of observed time series. Stated similarly, the goal of the generator neural network is to increase the error rate of the discriminator neural network.

In some embodiments, as is illustrated in FIG. 2, observed time series 118 can include observed time series data can originate from an industrial machine 210. Such a machine includes hardware 214 that permits of otherwise facilitates specific functionality of the industrial machine 210. For example, the industrial machine 210 can be embodied in or can include an industrial boiler. Thus, the hardware 214 can include a hermetically sealable vat, tubing for ingress of fluid into the vat and other tubing for the egress of the fluid; valves for control of fluid injection into the vat; valves that control fluid (liquid and/or gas) egress from the vat; heater devices, one or more pumps to supply fluid to the vat; and the like. In another example, the industrial machine 210 can be embodied in or can include a gas turbine. Thus, the hardware 214 can include blades, a rotor, a compressor, a combustor, and the like. In yet another example, the industrial machine 210 can be embodied in or can include a milling machine. As such, the hardware 214 can include a motor, a spindle (or a shaft) mechanically coupled to the motor, and a table. The motor can be referred to as spindle motor and can be supplied with AC current and DC current for operation.

A group of sensor devices can be integrated into or otherwise coupled to the hardware 214 to collect data indicative or otherwise representative of an operational state of the industrial machine 210. In some embodiments, the group of sensor devices can be homogeneous, including several sensor devices of a same type (e.g., pressure meters, temperature meters, or another type of sensor device). In other embodiments, the group of sensor devices can be heterogeneous, where a first subset of the group of sensor devices corresponds to sensor devices of a first type and a second subset of the group of sensor devices corresponds to sensor devices of a second type. For instance, such a group of sensor devices can include pressure meter(s) and temperature meter(s). As is illustrated in FIG. 2, the group of sensor devices includes a sensor device 218₁, a second device 218₂, . . . , a sensor device D-1 218_{D-1}, and a sensor device D 218_{D}. Here D is a natural number greater than unity. Open, block arrows linking respective sensors and the hardware 114 depict integration of a sensor device into the hardware 114 or coupling of the sensor device to the hardware 114. In scenario in which the industrial machine 210 is embodied in or includes a milling machine, the group of sensor devices can include multiples sensor devices (e.g., D>3) of three types of sensor devices: acoustic emission sensor(s), vibration sensor(s), and current sensor(s). Each one of the group of sensors can be mounted at a respective position on the milling machine.

Each sensor device of the group of sensor devices 2181-218_{D} can supply (e.g., generate and send) output data indicative or otherwise representative of magnitude of a physical property probed by the sensor device. Generation of a datum corresponds to a measurement of the sensor device. The data can be generated at defined times over a defined interval or several defined intervals. A time interval can correspond, for example, to a measurement run (or an experiment). For instance, that data can be generated in nearly real time, periodically, according to a schedule, or in response to polling by an external device. Thus, the data can form a time series that can be sent, for example, to one or more memory devices 270 (generically referred to as observed time series data 270).

Therefore, in one embodiment, the time series 118 (shown in FIG. 1) that is received at a discriminator network module 120 can be formatted as an array having a first defined dimension Nₛ (a natural number) and a second defined dimension D. Here, Nₛ represents a number of consecutive data samples over a defined time interval.

With further reference to FIG. 2 and the scenario in which the industrial machine 210 is embodied in or includes a milling machine, the acoustic emission sensor(s), vibration sensor(s), and current sensor(s) can probe (i) AC current that energizes a motor that causes motion of a spindle of the milling machine (the motor referred to as the spindle motor); (ii) DC current at the spindle motor; (iii) vibration of a table of the milling machine; (iv) vibration of the spindle; (v) acoustic emission at a table of the milling machine; and (vi) acoustic emission at the spindle over one or more measurement runs under various operating conditions. As such, time series data 118 can be formatted or otherwise configured, for example, as an array having a first dimension Ns and a second dimension D=6, where D=6 represents the foregoing six types of measurements (i) to (vi) that can be performed at the milling machine.

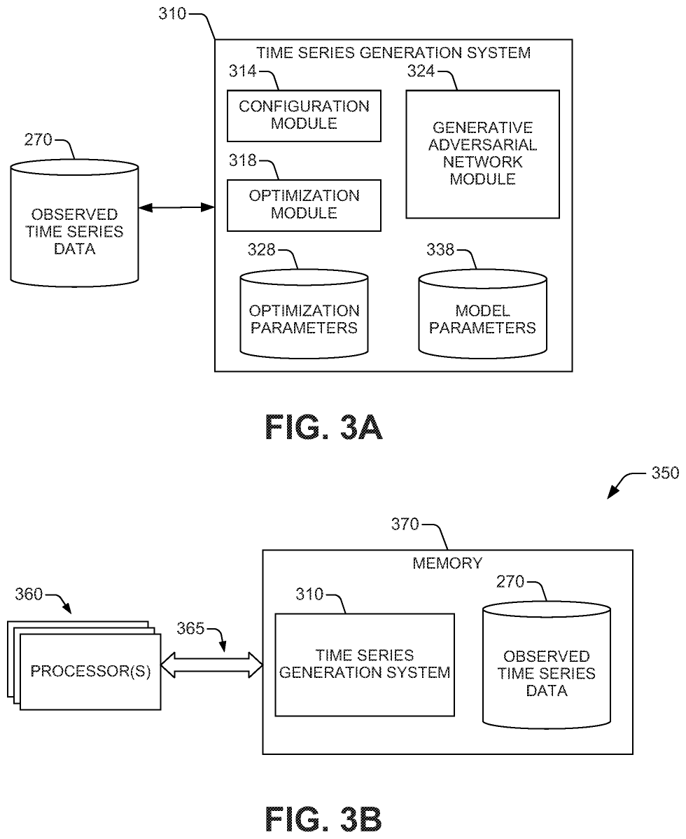

FIG. 3 presents an example of a time series generation system 310 in accordance with one or more embodiments of the disclosure. The illustrated time series generation system 310 includes a configuration module 314 that can configure a GAN in accordance with aspects of the disclosure. Specifically, the configuration module 214 can configure a discriminator network that can be embodied in or can include, for example, a deconvolutional neural network that includes multiple layers of units (or artificial neurons). Each one of the multiple layers can include a respective set of operations, weight computation, convolution or filtering, activation, and the like. The discriminator network can have a differentiable function [symbol] that is representative of the operations that can be implemented in the generator network. Thus, [symbol] also is representative of an output of the deconvolutional neural network, after such operations have been implemented.

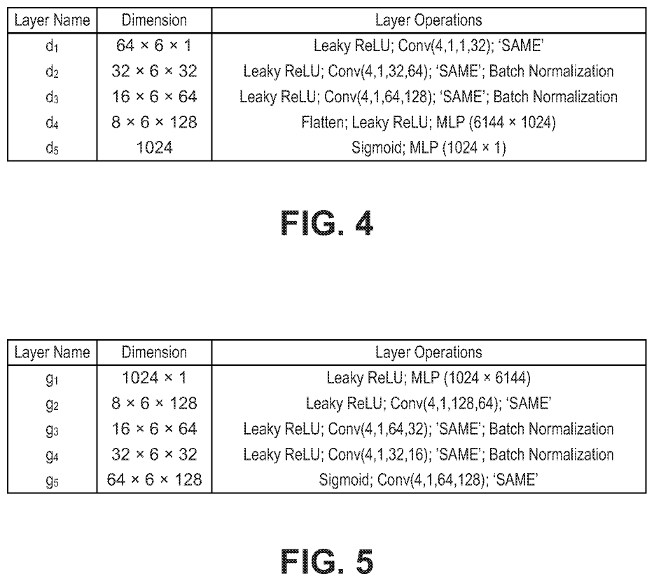

The configuration module 314 can configure a discriminator network having almost any number of layers of units (e.g., three layers, four layers, five layers, or the like). In some embodiments, the configuration module 314 configures a discriminator network having five layers, which for the sake of nomenclature, are labeled as d₁, d₂, d₃, d₄, and d₅. FIG. 4 presents a table that characterizes an example of a layer structure of a discriminator neural network in accordance with one or more embodiments of the disclosure. As is illustrated in FIG. 4, a first layer, e.g., d₁, can receive input time series data (e.g., time series data 118). Accordingly, such an input layer has a dimension in feature space that is consistent with the structure of the input time series data. In a scenario in which the input time series data is arranged as an array Nₛ×D, the input layer can have a dimension Nₛ×D×1. Thus, in the example scenario discussed hereinbefore in which the industrial machine 210 is a milling machine, the first layer, e.g., d₁, can have a dimension 64×6×1. In addition, the first layer, e.g., d₁, is a convolution layer and applies leaky rectified linear unit (Leaky ReLU) activation. In some instances, a slope of leak in the Leaky ReLU can be configured to 0.2. In FIG. 4, the descriptor ‘SAME’ indicates that zero-padding is used to perform convolution in a manner that the input and the output of the convolution layer have the same size. Such a descriptor has the same meaning when present in connection with layer operations of other layers in the discriminator neural network.

As is further illustrated in FIG. 4, the discriminator neural network also includes a second layer, e.g., d₂, that has a dimension in feature space equal to 32×6×32. The second layer is a convolution layer and applies Leaky ReLU activation. In some instances, a slope of leak in the Leaky ReLU can be configured to 0.2. The convolution layer is characterized by four parameters (H, W, P, N). where H and W (each an integer number) are indicative of a height and width, respectively, of the convolutional filter of the convolution layer; and P and N (each an integer number) are indicative, respectively of number of input channels and number of output channels. As such, the convolution layer in the second layer has the following parameters: (4, 1, 1, 32).

The discriminator neural network further includes a third layer, e.g., d₃, having a dimension in feature space equal to 16×6×64. The third layer is a convolution layer (4, 1, 32, 64) and applies Leaky ReLU activation. In some instances, a slope of leak in the Leaky ReLU can be configured to 0.2. Each one of the second layer and the third layer utilizes batch normalization, where the input to each unit in the convolution layer is normalized to have zero mean and unit variance. Batch normalization can stabilize learning.

The discriminator neural network further includes a fourth layer, e.g., d₄, having a dimension has a dimension in feature space equal to 1024. The fourth layer is a multilayer perceptron (MLP) layer that is flattened (indicated as “Flatten” in FIG. 4) and applies Leaky ReLU activation. In some instances, a slope of leak in the Leaky ReLU can be configured to 0.2. The output of the fourth layer is supplied to a fifth layer (e.g., d₅, output layer) that is a single MLP that applies sigmoid activation. No batch normalization is applied in the fourth or fifth layer.

With further reference to FIG. 3A, the configuration module 314 also can configure a generator neural network that can be embodied in or can include, for example, in a convolutional neural network that includes multiple layers. Each one of the multiple layers includes a respective set of operations (see, e.g., FIG. 5). The generator network can have a differentiable function [symbol] that is representative of the operations that can be implemented in the generator network. Thus, [symbol] also is representative of an output of the convolutional neural network, after such operations have been implemented.

More specifically, in some embodiments, the configuration module 314 configures a generator network having five layers, which for the sake of nomenclature, are labeled as g₁, g₂, g₃, g₄, and g₅. FIG. 5 presents a table that characterizes an example of a layer structure of a generator neural network in accordance with one or more embodiments of the disclosure. As is illustrated in FIG. 5, a first layer, e.g., g₁, can receive M samples of noise (e.g., noise data 104) that can be uniformly distribution or another type of random noise. Accordingly, such an input layer has a dimension in feature space 1024×1, corresponding to M=1024. It is noted that the disclosure is not limited to such value nor is the disclosure limited to a number of noise samples that is equal to a power of 2. Such a first layer, e.g., g₁, is an MLP layer that applies Leaky ReLU activation. In some instances, a slope of leak in the Leaky ReLU can be configured to 0.2.

As is further illustrated in FIG. 5, the generator neural network also includes a second layer, e.g., g₂, that has a dimension of 8×6×128. The second layer is a convolution layer (4, 1, 128, 64) and applies Leaky ReLU activation. The generator neural network further includes a third layer, e.g., g₃, having a dimension in feature space equal to 16×6×64. The third layer is a convolution layer (4, 1, 64, 32) and applies Leaky ReLU activation. In addition, the generator neural network includes a fourth layer, e.g., g₄, having a dimension has a dimension in feature space equal to 32×6×32. The fourth layer is a convolution layer (4, 1, 32, 16) and applies Leaky ReLU activation. Each one of the third layer and fourth layer utilizes batch normalization. Output of the fourth layer is supplied to a fifth layer that is convolutional layer (4, 1, 64, 128) and applies sigmoid activation. Each one of the second layer, the third layer, the fourth layer, and the fifth layer relies on zero-padding in a manner consistent with the ‘SAME’ descriptor defined hereinbefore. In some instances, for each layer in which Leaky ReLU activation a slope of the leak can be configured to 0.2.

The generator neural network need not be configured with a same number of layers than the discriminator network has. In some embodiments, as is illustrated in FIGS. 4-5, the generator neural network and the discriminator neural network can have a common number of layers. In other embodiments, the generator neural network can have a different number of layers from that of the discriminator neural network.

With further reference to FIG. 3A, In order to generate a GAN that permits generating a synthetic time series, the GAN that is configured by the configuration module 314 is trained. Specifically, the discriminator network and the generator network are optimized with respect to an objective function that is based at least on [symbol] and [symbol] . To that end, the time series generation system 310 includes an optimization module 318 that determines a first group of parameters that define [symbol] and a second group of parameters that define [symbol] . Functions [symbol] and [symbol] are referred to as generator and discriminator, respectively. Each one of the first group of parameters and the second group of parameters results in a value of the objective function that is satisfactory. In other words, changes to the parameters in either the first group or the second group, or both groups, yields changes in a value of the objective function that are within a defined threshold value.

The objective function to train the GAN configured by the configuration module 314 is denoted as V ( [symbol] , [symbol] ). Here, again, [symbol] is a differentiable function that represents the generator network and [symbol] is another differentiable function that represents the discriminator network.

The optimization problem that is solved to train such a GAN is defined as follows:

$$\begin{matrix}{max}_{𝒟} {min}_{𝒢} V ( 𝒢 , 𝒟 ) , & ( 1 ) \\ where & \\ V ( 𝒢 , 𝒟 ) = {𝔼}_{{p}_{d} ( x )} log 𝒟 ( x ) + {𝔼}_{{p}_{g} ( x )} log ( 1 - 𝒟 ( 𝒢 ( z ) ) . & ( 2 )\end{matrix}$$

Here, x represents a multi-dimensional vector of observed values (measurements), e.g., an observed time series, and z represents a multi-dimensional vector of uniformly distributed random values or another type of noise values. Further, p₉ (⋅) represents the probability distribution of synthetic data, e.g., a synthetic time series, and p_{d}(x) represents the probability distribution of observed data. In some embodiments, explicit expressions for such distributions are unavailable and a numeric computation can be implemented. Furthermore, [symbol] _{p(⋅)}(⋅) represents the expectation operator for the probability distribution p(⋅).

The time series generation system 310 includes an optimization module 318 that can implement adversarial training in order to determine an adequate GAN, as is disclosed herein. Without intending to be bound by theory, it is noted that adversarial attempts to force p_{g}(x) to be equal to p_{d}(x). For a specific generator, there is a unique optimal discriminator:

$${𝒟}^{*} ( x ) = \frac{{p}_{d} ( x )}{{p}_{d} ( x ) + {p}_{g} ( x )} . \qquad ( 3 )$$

Therefore, the generator consistent with [symbol] *(x) is optimal when p_{g}(x)=p_{d}(x), implying that the optimal discriminator predicts 0.5 for all samples drawn from x.

The optimization module 318 can solve the optimization problem in Eq. (1) by jointly minimizing the objective function V( [symbol] ) with respect to [symbol] and maximizing V( [symbol] ) with respect to [symbol] . As such, the optimization module 318 can alternatingly update the first group of parameters that defines [symbol] and the second group of parameters that define [symbol] until a convergence criterion is satisfied, resulting in a satisfactory [symbol] and a satisfactory [symbol] . More concretely, in some embodiments, the optimization module 318 can solve the optimization problem posed by Eq. (1) by performing a stochastic gradient descent (SGD) process. In one example, the SGD process can include mini-batch SGD, with a mini-batch size equal to 128. In one example, performance of the SGD process can implement a first-order gradient-based optimization of the objective function V( [symbol] ) based on adaptive estimates of lower-order moments. The learning rate in such a process can be configured to 0.0002, and first and second hyper-parameters to control exponential decay rates can be configured at 0.500 and 0.999, respectively. Initial first weights in the discriminator neural network and initial second weights in the generator neural network can be initialized according to a uniform probability distribution that has a zero mean and a defined variance that depends on the inverse of a number of units linked to the weights being initialized.

The time series generation system 310 can include one or more memory devices 328 that can retain various parameters (referred to as optimization parameters 328) that define, amongst other things, the stochastic gradient descent process. Such parameters can be retained within data structures referred to as model parameters, and can include a learning rate, slope of leak in Leaky ReLU, initial values of weights for each layer in the discriminator network and each layer in the generator network, and the like, in accordance with aspects described herein.

In some embodiments, the optimization module 318 can iteratively update the discriminator [symbol] (e.g., perform changes to the parameters that define the discriminator) by ascending the stochastic gradient of the objective function V( [symbol] ), while maintaining unchanged the parameters that define the generator [symbol] . In a subsequent iteration, the optimization module 318 can update the generator [symbol] (e.g., perform changes to the parameters that define the generator) by descending the stochastic gradient of the objective function V( [symbol] ). To evaluate the objective function, the optimization module 318 can access observed time series data from the memory device(s) 270 and can apply a current discriminator and generator to the accessed time series data.

After consecutive updates of the discriminator and the generator, the optimization module 318 can determine if a next iteration is to be implemented. To that point, the optimization module can evaluate if current parameters yield a change in V( [symbol] ) that satisfies a convergence criterion. In response to ascertaining the convergence criterion is satisfied, the optimization module 318 can terminate the SGD process.

As mentioned solving the optimization problem in Eq. (1) trains a GAN, resulting in satisfactory parameters (e.g., parameters obtained after convergence of the of iterative SGD process) that define the discriminator network and the generator network. Upon or after the optimization problem is solved, the optimization module 318 can retain the satisfactory parameters in one or more memory devices 338, within data structures referred to as model parameters 338.

FIG. 3B presents an example of a computing system 350 to generate synthetic time series in accordance with aspects of this disclosure. As is illustrated in FIG. 3B, the computing system 350 can include one or more memory devices 370 (generically referred to as memory 370) that can retain or otherwise store the time series generation system 310. The computing system includes one or more processors 350. In one example, the processor(s) 350 can be embodied in or can constitute a graphics processing unit (GPU), a plurality of GPUs, a central processing unit (CPU), a plurality of CPUs, an application-specific integrated circuit (ASIC), a microcontroller, a programmable logic controller (PLC), a field programmable gate array (FPGA), a combination thereof, or the like. In some embodiments, the processor(s) 180 can be arranged in a single computing apparatus (e.g., a blade server). In other embodiments, the processor(s) 180 can be distributed across two or more computing apparatus.

The processor(s) 360 can be functionally coupled to the memory 370 by means of a communication architecture 365. The communication architecture 365 is suitable for the particular arrangement (localized or distributed) of the processor(s) 360. As such, the communication architecture 365 can include base station devices; router devices; switch devices; server devices; aggregator devices; bus architectures; a combination of the foregoing; or the like.

In the illustrated computing system 350, the time series generation system 310 can be embodied in or can include machine-accessible instructions (e.g., computer-readable and/or computer-executable instructions) that can be accessed and executed by at least one of the processor(s) 360. The processor(s) 350 can execute the time series generation system 310 to cause the computing system to generate synthetic time series using a GAN as is disclosed herein. Similarly, the memory 370 also can retain or otherwise store the observed time series data 270.

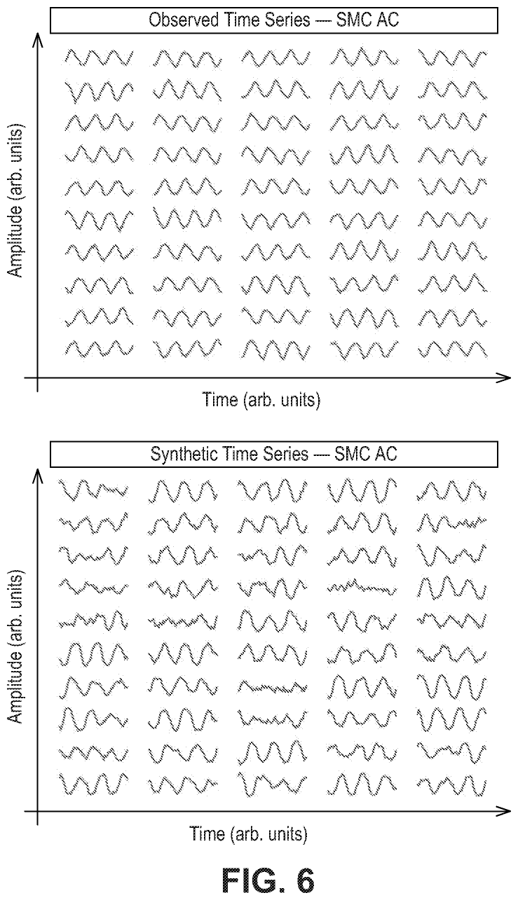

The time series generation system 310 includes a GAN module 324 that can utilize or otherwise leverage model parameters to generate time series data using an optimized generator function [symbol] ^{(opt)}. FIGS. 6-11 illustrate performance of an example GAN configured as is shown in FIGS. 4-5 and trained in accordance with aspects described herein. In each one of FIGS. 6-11, time is represented in the abscissa, in arbitrary units (“arb. units”). Time series are shown shifted in time relative to one another for the sake of clarity. Magnitude of respective observables is represented in the ordinate, in arbitrary units and labeled “Amplitude.” Specifically, FIG. 6 presents examples of observed time series and synthetic time series generated in accordance with one or more embodiments of the disclosure. Both the observed time series and the synthetic time series correspond to AC current that energizes a spindle motor of a milling machine. As mentioned, for the sake of nomenclature, the time series are generically labeled as SMC AC.

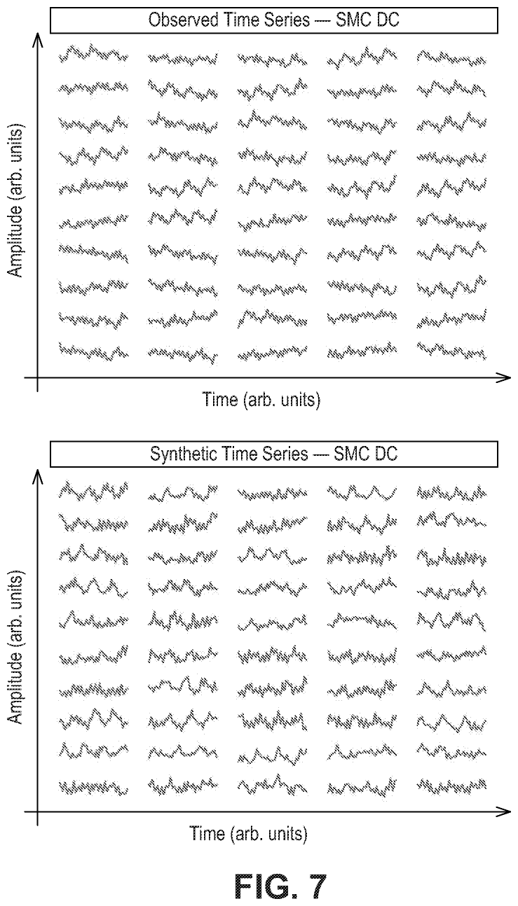

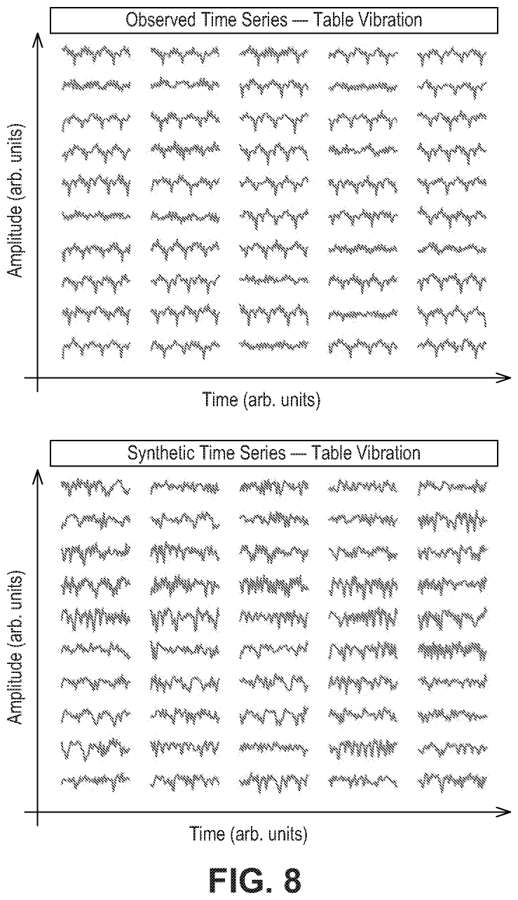

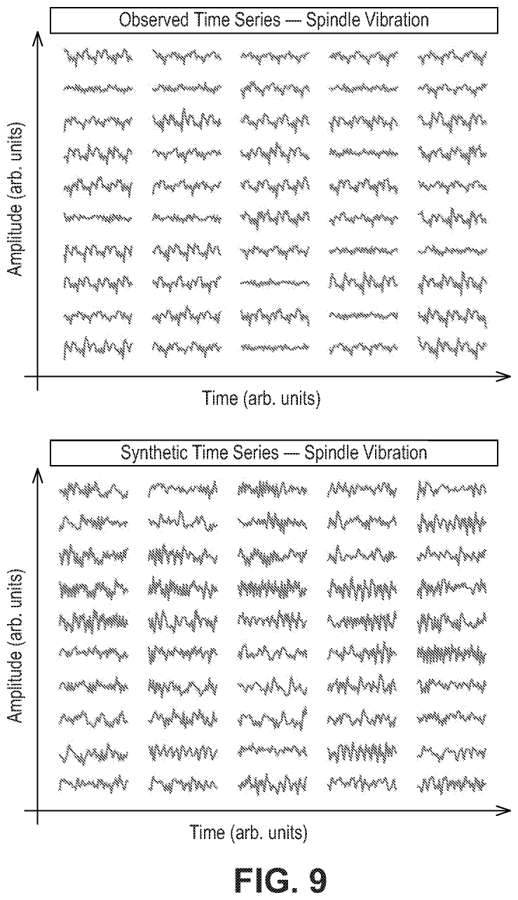

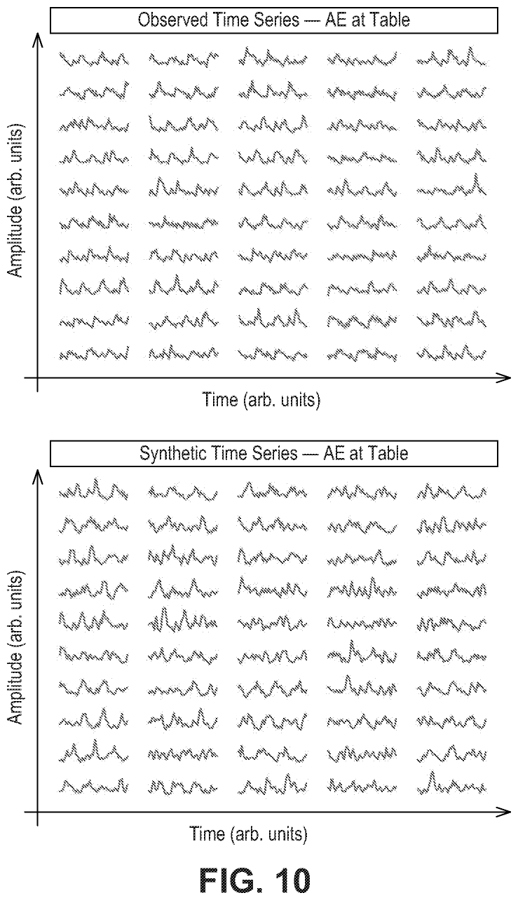

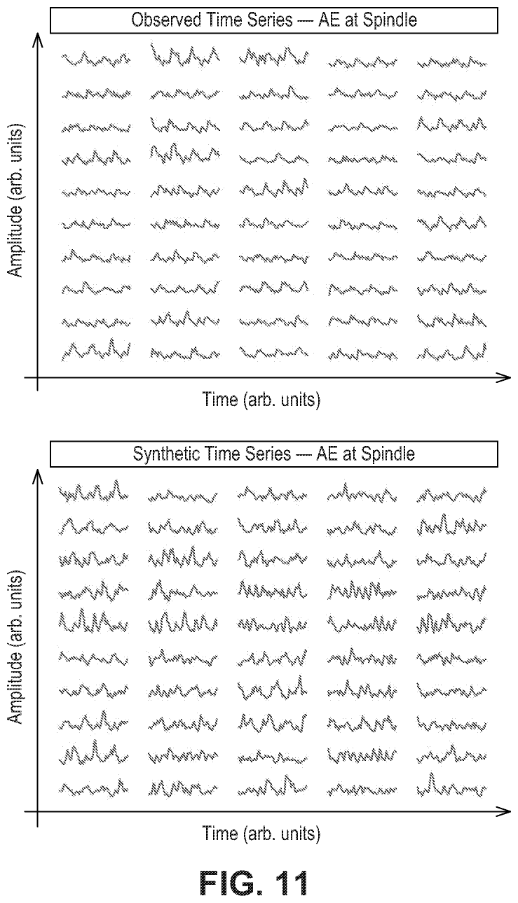

FIG. 7 presents other examples of observed time series and synthetic times series generated in accordance with one or more embodiments of the disclosure, both types of time series correspond to DC current that circulates in the spindle motor of the milling machine. As mentioned, for the sake of nomenclature, the time series are generically labeled as SMC DC. FIG. 8 presents other examples of observed time series and synthetic times series generated in accordance with one or more embodiments of the disclosure, both types of time series correspond to vibration of table of the milling machine. FIG. 9 presents other examples of observed time series and synthetic times series generated in accordance with one or more embodiments of the disclosure, both types of time series represent vibration of the spindle of the milling machine. FIG. 10 presents other examples of observed time series and synthetic times series generated in accordance with one or more embodiments of the disclosure, both types of time series represent acoustic emission (AE) at a table in the milling machine. FIG. 11 presents other examples of observed time series and synthetic times series generated in accordance with one or more embodiments of the disclosure, both types of time series represent AE at a spindle in the milling machine.

As it can be gleaned from FIGS. 6-11, the synthetic time series generated using a GAN in accordance with this disclosure appear strikingly similar to the observed time series. Therefore, GANs according to aspects of this disclosure can provide the high-quality, realistic time series samples.

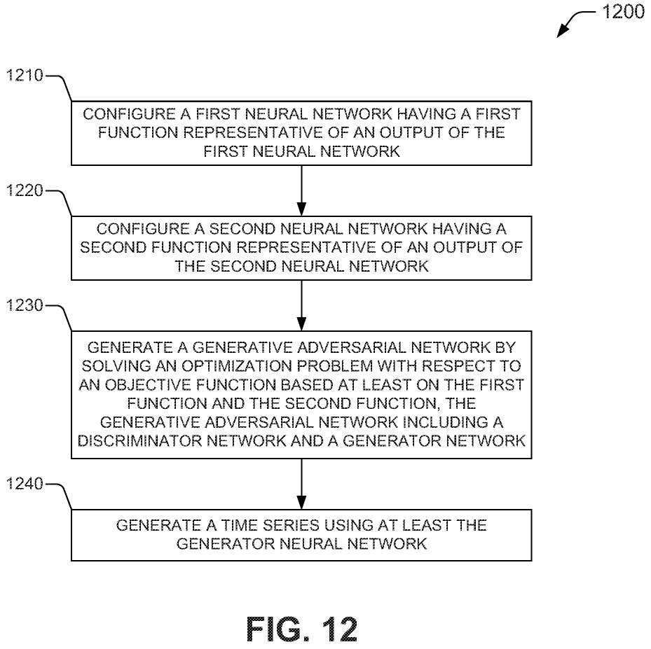

In view of various aspects described herein, examples of methods that can be implemented in accordance with this disclosure can be better appreciated with reference to FIG. 12. For purposes of simplicity of explanation, the exemplified methods (and other techniques disclosed herein) are presented and described as a series of operations. It is noted, however, that the exemplified methods and any other techniques of this disclosure are not limited by the order of operations. Some operations may occur in different order than that which is illustrated and described herein. In addition, or in the alternative, some operations can be performed essentially concurrently with other operations (illustrated or otherwise). Further, not all illustrated operations may be required to implement an exemplified method or technique in accordance with this disclosure. Furthermore, in some embodiments, two or more of the exemplified methods and/or other techniques disclosed herein can be implemented in combination with one another to accomplish one or more elements and/or technical improvements disclosed herein.

In some embodiments, one or several of the exemplified methods and/or other techniques disclosed herein can be represented as a series of interrelated states or events, such as in a state-machine diagram. Other representations also are possible. For example, interaction diagram(s) can represent an exemplified method and/or a technique in accordance with this disclosure in scenarios in which different entities perform different portions of the disclosed methodologies.

It should be further appreciated that the example methods disclosed in this specification can be retained or otherwise stored on an article of manufacture (such as a computer-program product) in order to permit or otherwise facilitate transporting and transferring such example methods to computers for execution, and thus implementation, by processor(s) or for storage in a memory.

Methods disclosed throughout the subject specification and annexed drawings are capable of being stored on an article of manufacture to facilitate transporting and transferring such methodologies to computers or other types of information processing machines or processing circuitry for execution, and thus implementation by a processor or for storage in a memory device or another type of computer-readable storage device. In one example, one or more processors that perform a method or combination of methods disclosed herein can be utilized to execute programming code instructions retained in a memory device or any computer-readable or machine-readable storage device or non-transitory storage media, to implement one or several of the exemplified methods and/or other techniques disclosed herein. The programming code instructions, when executed by the one or more processors can implement or carry out the various operations in the exemplified methods and/or other technique disclosed herein.

The programming code instructions, therefore, provide a computer-executable or machine-executable framework to implement the exemplified methods and/or other techniques disclosed herein. More specifically, yet not exclusively, each block of the flowchart illustrations and/or combinations of blocks in the flowchart illustrations can be implemented by the programming code instructions.

FIG. 12 presents a flowchart of an example method 1200 for generating time series in accordance with one or more embodiments of the disclosure. The example method 1200 can be implemented, entirely or in part, by a computing system having one or more processors, one or more memory devices, and/or other types of computing resources. In some embodiments, the computing system can be embodied in the computing system 350. Thus, the computing system that implements the example method 100 can include the time series generation system 310.

At block 1210 the computing system can configure a first neural network having a first function representative of an output of the first neural network. In some embodiments, the first neural network can embody a discriminator network and, thus, the first function can be embodied in [symbol] disclosed hereinbefore. In one aspect, configuring the first neural network can include configuring a deconvolutional neural network having multiple layers (e.g., three layers, four layers, five layers, or the like), each layer including a respective set of operations (see, e.g., FIG. 4).

At block 1220 the computing system can configure a second neural network having a second function representative of an output of the second neural network. In the embodiments referred to above in connection with block 1110, the second neural network can be embodied in a generator network. As such, the second function can be embodied in [symbol] disclosed hereinbefore. In one aspect, configuring the second neural network can include configuring a convolutional neural network having multiple layers (e.g., three layers, four layers, five layers, or the like), each layer including a respective set of operations (see, e.g., FIG. 5)

In one embodiment, the second neural network has a same number of layers as the first neural network. Again, the disclosure is not so limited and the number of layers in the second neural network can different from the number of layers in the first neural network.

At block 1230, the computing system can generate a GAN by solving an optimization problem with respect to an objective function based at least on the first function (e.g., [symbol] ) and the second function (e.g., [symbol] ). In some embodiments, the optimization problem can correspond to the optimization problem posed in Eq. (1). To solve the optimization problem, the computing system can jointly minimize the objective function with respect to the second function and maximize the objective function with respect to the first function. In some aspects, as is disclosed herein, jointly minimizing the objective function can include updating alternatingly the first function and the second function until a convergence criterion is satisfied, resulting in a satisfactory first function and a satisfactory second function. More specifically, as is disclosed herein, the computing system can iteratively update the first function (e.g., perform changes to the parameters that define the first function) by ascending the stochastic gradient of the objective function, while maintaining unchanged the parameters that define the second function. In a subsequent iteration, the computing system can update the second function (e.g., perform changes to the parameters that define the second function) by descending the stochastic gradient of the objective function. The computing system can evaluate a convergence criterion after each iteration including an update to the first function and an update to the second function. The computing system can terminate such alternating updates in response to the criterion being satisfied.

At block 1240, the computing system can generate a time series using at least the generator neural network. For example, the computing system can generate one or more of the time series illustrated in FIGS. 6-11. In some embodiments, the time series corresponds to a time dependent observable quantity in an industrial apparatus. Therefore, generating the time series can include receiving an array of uniformly distributed random values and applying the generator network to the array, resulting in the time series. As is disclosed herein, the array can have a defined first dimension (e.g., Nₛ) indicative of a number of consecutive samples to be generated) and a defined second dimension indicative of a number of sensor device present in the industrial apparatus.

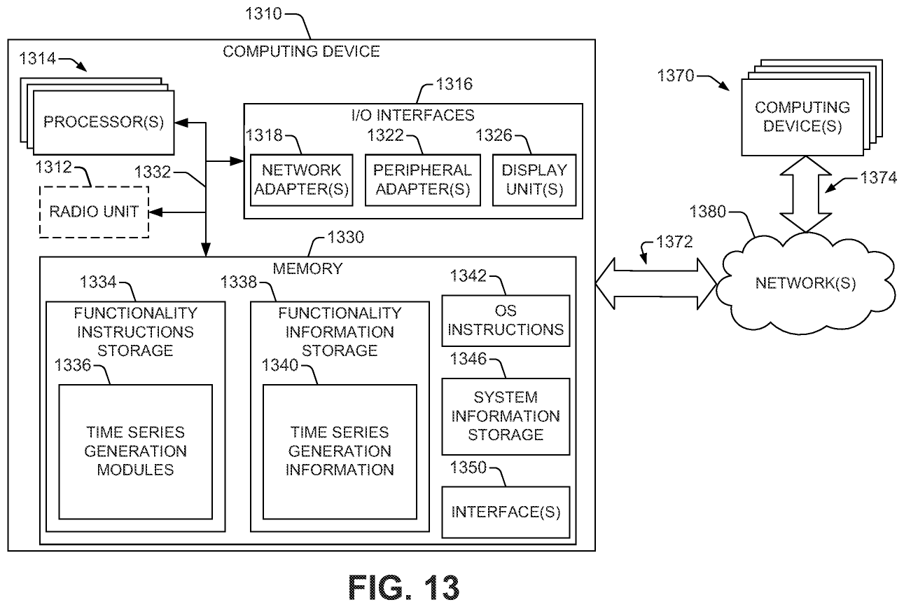

FIG. 13 presents an example of a computational environment in which time series can be generated using generative adversarial networks in accordance with one or more embodiments of the disclosure. The exemplified operational environment 1300 is merely illustrative and is not intended to suggest or otherwise convey any limitation as to the scope of use or functionality of the operational environment's architecture. In addition, the exemplified operational environment 1300 depicted in FIG. 13 should not be interpreted as having any dependency or requirement relating to any one or combination of modules or other types of components illustrated in other example operational environments of this disclosure.

The example operational environment 1300 or portions thereof can embody or can constitute other ones of the various operational environments and systems described hereinbefore. As such, the computing device 1310, individually or combination with at least one of the computing device(s) 1370), can embody or can constitute the time series generation system 310 described herein.

The computational environment 1300 represents an example implementation of the various aspects or elements of the disclosure in which the processing or execution of operations described in connection with generation of synthetic time series in accordance with aspects disclosed herein can be performed in response to execution of one or more software components at the computing device 1310. Such one or more software components render the computing device 1310 (or any other computing device that contains the software component(s) a particular machine for generating synthetic time series using a GAN, in accordance with aspects described herein, among other functional purposes.

A software component can be embodied in or can include one or more computer-accessible instructions (e.g., computer-readable and/or computer-executable instructions). In some embodiments, as mentioned, at least a portion of the computer-accessible instructions can be executed to perform at least a part of one or more of the example methods (e.g., method 1200 illustrated in FIG. 12) and/or other techniques described herein.

For instance, to embody one such method, at least the portion of the computer-accessible instructions can be retained in a computer-readable storage non-transitory medium and executed by one or more processors (e.g., at least one of processor(s) 1314). The one or more computer-accessible instructions that embody or otherwise constitute a software component can be assembled into one or more program modules, for example. Such program module(s) can be compiled, linked, and/or executed (by one or more of the processor(s) 1314) at the computing device 1310 or other computing devices.

Further, such program module(s) can include computer code, routines, programs, objects, components, information structures (e.g., data structures and/or metadata structures), etc., that can perform particular tasks (e.g., one or more operations) in response to execution by one or more processors. At least one of such processor(s) can be integrated into the computing device 1310. For instance, the one or more processor that can execute the program module(s) can be embodied in or can include a non-empty subset the processor(s) 1314. In addition, at least another one of the processor(s) can be functionally coupled to the computing device 1310.

The various example embodiments of the disclosure can be operational with numerous other general purpose or special purpose computing system environments or configurations. Examples of well-known computing systems, environments, and/or configurations that can be suitable for implementation of various aspects or elements of the disclosure in connection with generation of synthetic time series in accordance with aspects of this disclosure can include personal computers; server computers; laptop devices; handheld computing devices, such as mobile tablets or e-readers; wearable computing devices; and multiprocessor systems. Additional examples can include, programmable consumer electronics, network personal computers (PCs), minicomputers, mainframe computers, blade computers, programmable logic controllers, distributed computing environments that comprise any of the above systems or devices, and the like.

As is illustrated in FIG. 13, the computing device 1310 includes one or more processors 1314, one or more input/output (I/O) interfaces 1316; one or more memory devices 1330 (collectively referred to as memory 1330); and a bus architecture 1332 (also termed bus 1332). The bus architecture 1332 functionally couples various functional elements of the computing device 1310. The bus 1332 can include at least one of a system bus, a memory bus, an address bus, or a message bus, and can permit or otherwise facilitate the exchange of information (data, metadata, and/or signaling) between the processor(s) 714, the I/O interface(s) 716, and/or the memory 730, or respective functional elements therein. In some scenarios, the bus 732 in conjunction with one or more internal programming interfaces 1350 (collectively referred to as interface(s) 1350) can permit or otherwise facilitate such exchange of information. In scenarios in which the processor(s) 1314 include multiple processors, the computing device 1310 can utilize parallel computing.

In some embodiments, the computing device 1310 can include, optionally, a radio unit 1312. The radio unit 1312 can include one or more antennas and a communication processing unit that can permit wireless communication between the computing device 1310 and another device, such as one of the computing device(s) 1370 or a sensor device.

The I/O interface(s) 1316 can permit or otherwise facilitate communication of information between the computing device 1310 and an external device, such as another computing device (e.g., a network element or an end-user device) or a sensor device. Such communication can include direct communication or indirect communication, such as the exchange of information between the computing device 1310 and the external device via a network or elements thereof. In some embodiments, as is illustrated in FIG. 13, the I/O interface(s) 1316 can include one or more of network adapter(s) 1318, peripheral adapter(s) 1322, and display unit(s) 1326. Such adapter(s) can permit or otherwise facilitate connectivity between the external device and one or more of the processor(s) 1314 or the memory 1330. For example, the peripheral adapter(s) 1322 can include a group of ports, which can include at least one of parallel ports, serial ports, Ethernet ports, V.35 ports, or X.21 ports. In certain embodiments, the parallel ports can comprise General Purpose Interface Bus (GPM), IEEE-1284, while the serial ports can include Recommended Standard (RS)-232, V.11, Universal Serial Bus (USB), FireWire or IEEE-1394.

At least one of the network adapter(s) 1318 can functionally couple the computing device 1310 to one or more computing devices 1370 via one or more communication links (wireless, wireline, or a combination thereof) and one or more networks 1380 that, individually or in combination, can permit or otherwise facilitate the exchange of information (data, metadata, and/or signaling) between the computing device 1310 and the one or more computing devices 1370. Such network coupling provided at least in part by the at least one of the network adapter(s) 1318 can be implemented in a wired environment, a wireless environment, or both. The network(s) 1380 can include several types of network elements, including base stations; router devices; switch devices; server devices; aggregator devices; bus architectures; a combination of the foregoing; or the like. The network elements can be assembled to form a local area network (LAN), a metropolitan area network (MAN), a wide area network (WAN), and/or other networks (wireless or wired) having different footprints.

Information that is communicated by at least one of the network adapter(s) 1318 can result from the implementation of one or more operations of a method (or technique) in accordance with aspects of this disclosure. Such output can be any form of visual representation, including textual, graphical, animation, audio, haptic, and the like. In some scenarios, each one of the computing device(s) 1370 can have substantially the same architecture as the computing device 1310. In addition or in the alternative, the display unit(s) 1326 can include functional elements (e.g., lights, such as light-emitting diodes; a display, such as a liquid crystal display (LCD), a plasma monitor, a light-emitting diode (LED) monitor, or an electrochromic monitor; combinations thereof; or the like) that can permit or otherwise facilitate control of the operation of the computing device 1310, or can permit conveying or revealing the operational conditions of the computing device 1310.

In one aspect, the bus architecture 1332 represents one or more of several possible types of bus structures, including a memory bus or a memory controller, a peripheral bus, an accelerated graphics port, and a processor or local bus using any of a variety of bus architectures. As an illustration, such architectures can include an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and the like.

The bus architecture 1332, and all other bus architectures described herein can be implemented over a wired or wireless network connection and each of the subsystems, including the processor(s) 1314, the memory 1330 and memory elements therein, and the I/O interface(s) 1316 can be contained within one or more remote computing devices 1370 at physically separate locations, connected through buses of this form, in effect implementing a fully distributed system.

In some embodiments, such a distributed system can implement the functionality described herein in a client-host or client-server configuration in which the time series generation modules 1336 or the time series generation information 1340, or both, can be distributed between the computing device 1310 and at least one of the computing device(s) 1370, and the computing device 1310 and at least one of the computing device(s) 1370 can execute such modules and/or leverage such information.

The computing device 1310 can include a variety of computer-readable media. Computer-readable media can be any available media (transitory and non-transitory) that can be accessed by the computing device 1310. In one aspect, computer-readable media can include computer non-transitory storage media (or computer-readable non-transitory storage media) and communications media. Example computer-readable non-transitory storage media can include, for example, both volatile media and non-volatile media, and removable and/or non-removable media. In one aspect, the memory 1330 can include computer-readable media in the form of volatile memory, such as random access memory (RAM), and/or non-volatile memory, such as read-only memory (ROM).

As is illustrated in FIG. 13, the memory 1330 can include functionality instructions storage 1334 and functionality information storage 1338. The functionality instructions storage 1334 can include computer-accessible instructions that, in response to execution (by at least one of the processor(s) 1314, for example), can implement one or more of the functionalities for generation of synthetic time series using a GAN, in accordance with this disclosure. The computer-accessible instructions can embody or can comprise one or more software components illustrated as time series generation modules 1336.

In one scenario, execution of at least one component of the time series generation modules 1336 can implement one or more of the techniques disclosed herein, such as the example method 1200. For instance, such execution can cause a processor (e.g., one of the processor(s) 1314) that executes the at least one component to carry out a disclosed example method or another technique of this disclosure.

It is noted that, in one aspect, a processor of the processor(s) 1314 that executes at least one of the time series generation modules 1336 can retrieve information from or retain information in one or more memory elements 1340 in the functionality information storage 1338 in order to operate in accordance with the functionality programmed or otherwise configured by the time series generation modules 1336. The one or more memory elements 1340 can be generically referred to as time series generation information 1340. Such information can include at least one of code instructions, information structures, or the like. For instance, at least a portion of such information structures can be indicative or otherwise representative of optimization parameters (e.g., optimization parameters 328); model parameters (e.g., model parameters 338); observed time series (e.g., observed time series 270); synthetic time series; a combination thereof; and the like, in accordance with aspects described herein.

In some embodiments, one or more of the time series generation modules 1336 can embody or can constitute, for example, the modules included in the time series generation system 310; namely, configuration module 314, optimization module 318, and/or generative adversarial network module 324 in accordance with aspects of this disclosure.

At least one of the one or more interfaces 1350 (e.g., application programming interface(s)) can permit or otherwise facilitate communication of information between two or more modules within the functionality instructions storage 1334. The information that is communicated by the at least one interface can result from implementation of one or more operations in a method of the disclosure. In some embodiments, one or more of the functionality instructions storage 1334 and the functionality information storage 1338 can be embodied in or can comprise removable/non-removable, and/or volatile/non-volatile computer storage media.

At least a portion of at least one of the time series generation modules 1336 or the timer series generation information 1340 can program or otherwise configure one or more of the processors 1314 to operate at least in accordance with the functionality disclosed herein to generate synthetic time series using at least a generative adversarial network. One or more of the processor(s) 1314 can execute at least one of the time series generation modules 1336 and leverage at least a portion of the information in the functionality information storage 1338 in order to provide management of calls from unknown callers in accordance with one or more aspects described herein.

It is noted that, in some embodiments, the functionality instructions storage 1334 can embody or can comprise a computer-readable non-transitory storage medium having computer-accessible instructions that, in response to execution, cause at least one processor (e.g., one or more of the processor(s) 1314) to perform a group of operations comprising the operations or blocks described in connection with the example method 1200 and other techniques disclosed herein.

The memory 1330 also can include computer-accessible instructions and information (e.g., data, metadata, and/or programming code instructions) that permit or otherwise facilitate the operation and/or administration (e.g., upgrades, software installation, any other configuration, or the like) of the computing device 1310. Accordingly, as is illustrated, the memory 1330 includes a memory element 1342 (labeled operating system (OS) instructions 1342) that contains one or more program modules that embody or include one or more operating systems, such as Windows operating system, Unix, Linux, Symbian, Android, Chromium, and substantially any OS suitable for mobile computing devices or tethered computing devices. In one aspect, the operational and/or architectural complexity of the computing device 1310 can dictate a suitable OS.

The memory 1330 further includes a system information storage 1346 having data, metadata, and/or programming code (e.g., firmware) that can permit or otherwise can facilitate the operation and/or administration of the computing device 1310. Elements of the OS instructions 1342 and the system information storage 1346 can be accessible or can be operated on by at least one of the processor(s) 1314.

While the functionality instructions storage 1334 and other executable program components (such as the OS instructions 1342) are illustrated herein as discrete blocks, such software components can reside at various times in different memory components of the computing device 1310 and can be executed by at least one of the processor(s) 1314. In certain scenarios, an implementation of the time series generation 1336 can be retained on or transmitted across some form of computer-readable media.

As is illustrated in FIG. 13, in some instances, the computing device 1310 can operate in a networked environment by utilizing connections to one or more remote computing devices 1370. As an illustration, a remote computing device can be a personal computer, a portable computer, a server, a router, a network computer, a peer device or other common network node, and so on. As described herein, connections (physical and/or logical) between the computing device 1310 and a computing device of the one or more remote computing devices 1370 can be made via one or more networks 1380, and various communication links (wireless or wireline). The network(s) 1380 can include several types of network elements, including base stations; router devices; switch devices; server devices; aggregator devices; bus architectures; a combination of the foregoing; or the like. The network elements can be assembled to form a local area network (LAN), a metropolitan area network (MAN), a wide area network (WAN), and/or other networks (wireless or wired) having different footprints.

In addition, as is illustrated the communication links can be assembled in a first group of communication links 1374 and a second group of communication links 1372. Each one of the communication links in both groups can include one of an upstream link (or uplink (UL)) or a downstream link (or downlink (DL)). Each one of the UL and the DL can be embodied in or can include wireless links (e.g., deep-space wireless links and/or terrestrial wireless links), wireline links (e.g., optic-fiber lines, coaxial cables, and/or twisted-pair lines), or a combination thereof.

The first group of communication links 1374 and the second group of communication links 1372 can permit or otherwise facilitate the exchange of information (e.g., data, metadata, and/or signaling) between at least one of the computing device(s) 1370 and the computing device 1310. To that end, one or more links of the first group of communication links 1374, one or more links of the second group of communication links 1374, and at least one of the network(s) 1380 can form a communication pathway between the communication device 1310 and at least one of the computing device(s) 1370.

In one or more embodiments, one or more of the disclosed methods can be practiced in distributed computing environments, such as grid-based environments, where tasks can be performed by remote processing devices (computing device(s) 1370) that are functionally coupled (e.g., communicatively linked or otherwise coupled) through at least one of network(s) 1310. In a distributed computing environment, in one aspect, one or more software components (such as program modules) can be located within both a local computing device (e.g., computing device 1310) and at least one remote computing device.

Various embodiments of the disclosure may take the form of an entirely or partially hardware embodiment, an entirely or partially software embodiment, or a combination of software and hardware. Further, as described herein, various embodiments of the disclosure (e.g., systems and methods) may take the form of a computer program product including a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can be embodied in or can include ROM; RAM; magnetic disk storage media; optical storage media; flash memory, etc.

At least some of the embodiments of the operational environments and techniques are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, special purpose computer, or other programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or technique put forth herein be construed as requiring that its acts or steps be performed in a specific order. Accordingly, where a process or a method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of embodiments described in the specification or annexed drawings, or the like.

As used in this application, the terms “environment,” “system,” “module,” “component,” “architecture,” “interface,” and the like refer to a computer-related entity or an entity related to an operational apparatus with one or more defined functionalities. The terms “environment,” “system,” “module,” “component,” “architecture,” “interface,” and “unit,” can be utilized interchangeably and can be generically referred to functional elements. Such entities may be either hardware, a combination of hardware and software, software, or software in execution. As an example, a module can be embodied in a process running on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can execute from various computer-readable non-transitory storage media having various data structures stored thereon. Modules can communicate via local and/or remote processes in accordance, for example, with a signal (either analogic or digital) having one or more data packets (e.g., data from one component interacting with another component in a local system, distributed system, and/or across a network such as a wide area network with other systems via the signal).

As yet another example, a module can be embodied in or can include an apparatus with a defined functionality provided by mechanical parts operated by electric or electronic circuitry that is controlled by a software application or firmware application executed by a processor. Such a processor can be internal or external to the apparatus and can execute at least part of the software or firmware application. Still in another example, a module can be embodied in or can include an apparatus that provides defined functionality through electronic components without mechanical parts. The electronic components can include a processor to execute software or firmware that permits or otherwise facilitates, at least in part, the functionality of the electronic components.

In some embodiments, modules can communicate via local and/or remote processes in accordance, for example, with a signal (either analog or digital) having one or more data packets (e.g., data from one component interacting with another component in a local system, distributed system, and/or across a network such as a wide area network with other systems via the signal). In addition, or in other embodiments, modules can communicate or otherwise be coupled via thermal, mechanical, electrical, and/or electromechanical coupling mechanisms (such as conduits, connectors, combinations thereof, or the like). An interface can include input/output (I/O) components as well as associated processors, applications, and/or other programming components.

As is utilized in this disclosure, the term “processor” can refer to any type of processing circuitry or device. A processor can be implemented as a combination of processing circuitry or computing processing units (such as CPUs, GPUs, or a combination of both). Therefore, for the sake of illustration, a processor can refer to a single-core processor; a single processor with software multithread execution capability; a multi-core processor; a multi-core processor with software multithread execution capability; a multi-core processor with hardware multithread technology; a parallel processing (or computing) platform; and parallel computing platforms with distributed shared memory.

Additionally, or as another example, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed or otherwise configured (e.g., manufactured) to perform the functions described herein.

In some embodiments, processors can utilize nanoscale architectures. in order to optimize space usage or enhance the performance of systems, devices, or other electronic equipment in accordance with this disclosure. For instance, a processor can include molecular transistors and/or quantum-dot based transistors, switches, and gates,

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (e.g., computer-readable instructions), information structures, program modules, or other information objects.

Memory components or memory devices disclosed herein can be embodied in either volatile memory or non-volatile memory or can include both volatile and non-volatile memory. In addition, the memory components or memory devices can be removable or non-removable, and/or internal or external to a computing device or component. Examples of various types of non-transitory storage media can include hard-disc drives, zip drives, CD-ROMs, digital versatile disks (DVDs) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable programmable ROM (EEPROM), or flash memory. Volatile memory can include random access memory (RANI), which acts as external cache memory. By way of illustration and not limitation, RANI is available in many forms such as synchronous RANI (SRAM), dynamic RANI (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory devices or memories of the operational or computational environments described herein are intended to include one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The flowchart and block diagrams in the Figures illustrate the architecture, functionality, and operation of possible implementations of examples of systems, methods, and computer program products according to various embodiments of the present disclosure. In this regard, each block in the flowchart or block diagrams may represent a module, segment, or portion of instructions, which includes one or more machine- or computer-executable instructions for implementing the specified operations. It is noted that each block of the block diagrams and/or flowchart illustration, and combinations of blocks in the block diagrams and/or flowchart illustration, can be implemented by special purpose hardware-based systems that perform the specified functions or operations or carry out combinations of special purpose hardware and computer instructions.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer-readable non-transitory storage medium within the respective computing/processing device.

What has been described herein in the present specification and annexed drawings includes examples of systems, devices, techniques, and computer program products that, individually or in combination, permit generating synthetic time series using a generative adversarial network. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

What is claimed is:

1. A computer-implemented method, comprising:
configuring a first neural network having a first function representative of an output of the first neural network;
configuring a second neural network having a second function representative of an output of the second neural network;
generating a generative adversarial network by solving an optimization problem with respect to an objective function based at least on the first function and the second function, the generative adversarial network including a discriminator neural network and a generator neural network; and
generating a synthetic time series using at least the generator neural network.

2. The method of claim 1, wherein the generating comprises:
receiving an array of uniformly distributed random values, the array having a defined first dimension and a defined second dimension corresponding to a number of sensor devices present in an industrial apparatus; and
applying the generator neural network to the array, resulting in the time series.

3. The method of claim 1, wherein the solving the optimization problem comprises jointly minimizing the objective function with respect to the second function and maximizing the objective function with respect to the first function.

4. The method of claim 3, wherein the jointly minimizing the objective function comprises updating alternatingly the first function and the second function until a convergence criterion is satisfied, resulting in a satisfactory first function and a satisfactory second function.

5. The method of claim 1, wherein the configuring the first neural network comprises configuring a deconvolutional neural network having multiple layers.

6. The method of claim 5, wherein the configuring the deconvolutional neural network comprises configuring a first layer of the multiple layers as a first convolution layer that applies leaky rectified linear unit (Leaky ReLU) activation;
configuring a second layer of the multiple layers as a second convolution layer that applies leaky ReLU activation and batch normalization;
configuring a third layer of the multiple layers as a third convolution layer that applies leaky ReLU activation and batch normalization;
configuring a fourth layer of the multiple layers as a flattened multilayer perceptron (MLP) layer that applies leaky ReLU activation; and
configuring an output layer of the multiple layers as an MLP layer that applies sigmoid activation.

7. The method of claim 1, wherein the configuring the second neural network comprises configuring a convolutional neural network having multiple layers.

8. The method of claim 5, wherein the configuring the deconvolutional neural network comprises configuring a first layer of the multiple layers as a multilayer perceptron (MLP) layer that applies leaky rectified linear unit (Leaky ReLU) activation;
configuring a second layer of the multiple layers as a first convolution layer that applies leaky ReLU activation;
configuring a third layer of the multiple layers as a second convolution layer that applies leaky ReLU activation and batch normalization;
configuring a fourth layer of the multiple layers as a third convolution layer that applies leaky ReLU activation and batch normalization; and
configuring an output layer of the multiple layers as a fourth convolution layer that applies sigmoid activation.

9. A system, comprising:
at least one memory device having stored therein computer-executable instructions; and
at least one processor configured to access the at least one memory device and further configured to execute the computer-executable instructions to:
configure a first neural network having a first function representative of an output of the first neural network;
configure a second neural network having a second function representative of an output of the second neural network;
generate a generative adversarial network by solving an optimization problem with respect to an objective function based at least on the first function and the second function, the generative adversarial network including a discriminator neural network and a generator neural network; and
generate a synthetic time series using at least the generator neural network.

10. The system of claim 9, wherein to generate the synthetic time series, the at least one processor is further configured to execute the computer-executable instructions to:
receive an array of uniformly distributed random values, the array having a defined first dimension and a defined second dimension corresponding to a number of sensor devices present in an industrial apparatus; and
apply the generator neural network to the array, resulting in the time series.

11. The system of claim 9, wherein to generate the generative adversarial network, the at least one processor is further configured to execute the computer-executable instructions to solve the optimization problem by jointly minimizing the objective function with respect to the second function and maximizing the objective function with respect to the first function.

12. The system of claim 11, wherein to jointly minimize the objective function, the at least one processor is further configured to execute the computer-executable instructions to update alternatingly the first function and the second function until a convergence criterion is satisfied, resulting in a satisfactory first function and a satisfactory second function.

13. The system of claim 9, wherein the first neural network comprises a deconvolutional neural network having multiple first layers, and wherein the second neural network comprises a convolutional neural network having multiple second layers.

14. A computer program product comprising at least one non-transitory storage medium readable by at least one processing circuit, the non-transitory storage medium having encoded thereon instructions executable by the at least one processing circuit to perform or facilitate operations comprising:
configuring a first neural network having a first function representative of an output of the first neural network;
configuring a second neural network having a second function representative of an output of the second neural network;
generating a generative adversarial network by solving an optimization problem with respect to an objective function based at least on the first function and the second function, the generative adversarial network including a discriminator neural network and a generator neural network; and
generating a synthetic time series using at least the generator neural network.

15. The computer program product of claim 14, wherein the generating comprises:
receiving an array of uniformly distributed random values, the array having a defined first dimension and a defined second dimension corresponding to a number of sensor devices present in an industrial apparatus; and
applying the generator neural network to the array, resulting in the time series.

16. The computer program product of claim 14, wherein the solving the optimization problem comprises jointly minimizing the objective function with respect to the second function and maximizing the objective function with respect to the first function.

17. The computer program product of claim 16, wherein the jointly minimizing the objective function comprises updating alternatingly the first function and the second function until a convergence criterion is satisfied, resulting in a satisfactory first function and a satisfactory second function.

18. The computer program product of claim 16, wherein the jointly minimizing the objective function comprises applying a stochastic gradient descent process.

19. The computer program product of claim 14, wherein the configuring the first neural network comprises configuring a deconvolutional neural network having multiple layers.

20. The computer program product of claim 14, wherein the configuring the second neural network comprises configuring a convolutional neural network having multiple layers.
